(19) United States
(12) Patent Application Publication
(10) Pub. No.: US 2026/0195276 A1
(43) Pub. Date: Jul. 9, 2026

(54) BASEBOARD MANAGEMENT CONTROL USING SHARED MEMORY

(71) Applicant: Hewlett Packard Enterprise Development LP, Spring, TX (US)

(72) Inventors: Mohan Parthasarathy, Bangalore (IN); Srinivasan Varadarajan Sahasranamam, Bangalore (IN); Venkatesh Nagaraj, Bangalore (IN)

(21) Appl. No.: 19/079,951

(22) Filed: Mar. 14, 2025

(30) Foreign Application Priority Data
Jan. 4, 2025 (IN) 202511000957

(51) Int. Cl. G06F 13/16; G06F 13/42

(52) U.S. Cl. CPC G06F 13/1663; G06F 13/1678; G06F 13/4221

(57) ABSTRACT

A system for exchanging data between a baseboard management controller (BMC) and a host processor is described herein. The system includes one or more host processors and a bus interface. The system also includes BMC circuitry that includes a BMC microcontroller configured to perform instructions received from one or more remote electronic devices to enable the one or more remote electronic devices to manage a server device on which the BMC circuitry resides. The system further includes a shared memory that is accessible by the one or more host processors via the bus interface and the BMC microcontroller. The one or more host processors and the BMC microcontroller are configured to exchange data with each other via the shared memory.

### BACKGROUND

Computing devices, such as desktop computers or servers, may deploy baseboard management controllers (BMCs) to remotely manage operations of the computing devices. The BMCs may exchange data with other portions of the computing devices.

### BRIEF DESCRIPTION OF THE DRAWINGS

Features, aspects, and advantages of the present disclosure will become better understood when the following detailed description is read with reference to the accompanying drawings in which like characters represent like parts throughout the drawings, wherein:

FIG. 1 is a block diagram illustrating a computing system that includes a shared memory used as an interface between a baseboard management controller (BMC) circuitry and host processor(s), in accordance with aspects of the present disclosure;

FIG. 2 is a block diagram of BMC circuitry that includes a compute express link (CXL) device to provide an interface between a BMC microcontroller and host processor(s), in accordance with aspects of the present disclosure;

FIG. 3 is a block diagram illustrating a computing system that includes a shared CXL device that includes shared memory used as an interface between BMC circuitries and host processor(s) of multiple baseboards, in accordance with aspects of the present disclosure;

FIG. 4 is a block diagram illustrating a computing system that includes a baseboard that includes a BMC circuitry that includes CXL device that includes shared memory used as an interface between the BMC circuitry and a host processor(s) of baseboard and as an interface between multiple baseboards of the computing system, in accordance with aspects of the present disclosure;

FIG. 5 is a sequence diagram illustrating a process for sharing Basic Input/Output System (BIOS) or Unified Extensible Firmware Interface (UEFI) variables between remote processor(s), BMC circuitry, and host processor(s) using a shared memory interface, in accordance with aspects of the present disclosure;

FIG. 6 is a sequence diagram illustrating a process for sharing telemetry data between remote processor(s), BMC circuitry, and host processor(s) using a shared memory interface, in accordance with aspects of the present disclosure;

FIG. 7 is a sequence diagram illustrating a process for securely loading an AI model from a remote processor(s) through BMC circuitry to host processor(s) using a shared memory interface, in accordance with aspects of the present disclosure;

FIG. 8 is a flow diagram of a process for switching between different interface types to communicate between a BMC circuitry and a host processor based on bandwidth consumption, in accordance with aspects of the present disclosure; and

FIG. 9 is a flow diagram of implemented instructions stored in a non-transitory, computer-readable medium to cause BMC circuitry to switch between different interface types to communicate between the BMC circuitry and a host processor based on bandwidth consumption, in accordance with aspects of the present disclosure.

### DETAILED DESCRIPTION

Servers may be located in multiple disparate physical sites, geographical locations, and/or data centers. However, these servers may be managed by a single entity across the different physical sites, geographical locations, and/or data centers. Thus, at least some of the servers may be remotely managed using remote computing devices.

To enable remote management, servers may include baseboard management controllers (BMCs) to provide remote processors with a control path to remotely manage operation of the servers. In some scale-up systems, there may be multiple baseboards having their own BMCs (e.g., one per chassis) and a rack management controller (RMC) that coordinates access with the BMCs to enable remote server management. To facilitate this control, the BMC(s) may connect to host processors of the servers to enable the BMCs to acquire data from and/or send data to the host processors. However, these connections may use interface types, such as an intelligent platform management interface (IPMI) or a channel interface (CHIF) types that are performance limited and/or do not perform well at scale. Furthermore, at least some of these interface types (e.g., IPMI) may be relatively bare with few features and/or lack the capability to implement features (e.g., security features) at scale. Alternatively, these connections may utilize an application programming interface (API), such as Redfish Protocol, which may function on scale-up systems but rely on some underlying interface, such as IPMI, to complete data transfers that may not be suitable for scale-up systems. For instance, the API may be a universal serial bus (USB) port emulating a virtual network interface card (VNIC).

Including the shared memory (e.g., compute express link (CXL) Type-3 device) as a communication path between BMCs and host processor(s) provides scalability. For instance, this scalability may be used for multiple partition systems that may have multiple BMCs providing telemetry data via the BMC in real-time or near-real-time that may be unavailable using IPMI or VNICs without potentially interfering with hardware error monitoring due to the consumption of relatively low resources for telemetry collection and processing.

Furthermore, the shared memory communication path may be used to supplement and/or replace other interface types (e.g., IPMI). In some implementations, the BMC may switchover between interface types (e.g., IPMI and CXL) based on bandwidth and/or resource consumption (e.g., telemetry frequency). When the bandwidth and/or resource consumption is greater than a threshold, the CXL interface type may be used while the IPMI interface is used when the bandwidth and/or resource consumption is lower than the threshold.

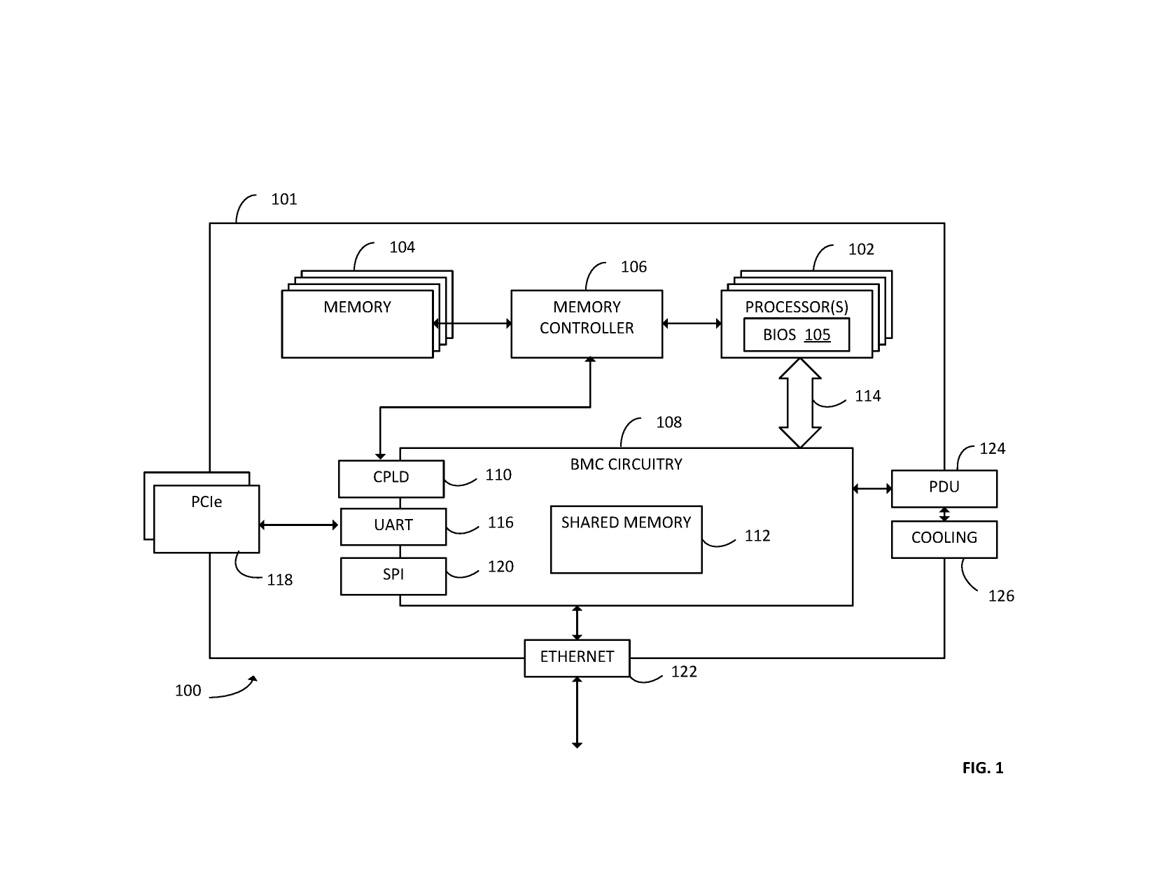

FIG. 1 is a diagram, illustrating a computing system 100 that includes a baseboard 101 that has one or more processors 102 coupled to the baseboard 101. The one or more processors 102 may include one or more processing resources, such as a central processing unit (CPU), a graphics processing unit (GPU), implemented using a field programmable gate array (FPGA), or a combination thereof. The one or more processors 102 may implement various stored programs. Accordingly, the computing system 100 may include any suitable computing devices that may utilize one or more processors 102, such as servers, desktop computers, laptop computers, tablet computers, cellular devices, wearable devices, and/or other computing devices.

Such programs or instructions executed by the one or more processors 102 may be stored in any suitable article of manufacture that includes one or more non-transitory and computer-readable media at least collectively storing the instructions or routines. For instance, the instructions may be stored in a memory 104 of the computing system 100. The memory 104 may be mounted on and/or coupled to the baseboard 101. The memory 104 may include any suitable articles of manufacture suitable for storing data and/or executable instructions that may be executed by the one or more processors 102. The memory 104 may include any suitable memory devices, such as random-access memory (RAM), including but not limited to, double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof. The memory 104 may include one or more different memory devices. Additionally or alternatively, the memory 104 may include a storage device, such as a Non-Volatile Memory Express (NVMe) device, a hard disk drive (HDD), a solid-state drive (SSD), an optical drive, another type of storage device, flash memory, read-only memory (ROM), or any combination thereof.

Programs encoded on such a computer program product of the articles of manufacture may also include instructions that may be executed by the one or more processors 102 to enable the computing system 100 to provide various functionalities. For instance, the programs implemented by the one or more processors 102 using the instructions stored on the non-transitory, computer-readable medium of the memory 104 may include a Basic Input/Output System (BIOS) 105 that is a type of firmware that may be stored on the baseboard 101, may perform a Power-On Self-Test (POST) to check that devices are functioning properly, configure hardware of the computing system 100, may load an operating system (OS), and manage data flow between the OS and connected devices of the computing system. The OS, once loaded into the one or more processors 102 by the BIOS 105, manages all other application programs and manages device hardware (e.g., the memory 104) and software resources.

To facilitate control of the memory 104 and/or exchange of data between the one or more processors 102 and the memory 104, the computing system 100 includes a memory controller 106. The memory controller 106 may be a hardware and/or software component that connects one or more diverse types of memory in the memory 104 to the one or more processors 102 (e.g., via a processor bus of the one or more processors 102). The memory controller 106 may be part of the one or more processors 102 and/or may be implemented on a separate chip mounted on a baseboard of the computing system. The memory controller 106 manages data flow between the memory 104 and the one or more processors 102 including memory read and write operations. During a power up of the computing system 100, the memory controller 106 configures and enables use of specific memory devices of the memory 104. Additionally, the memory controller 106 may handle various functions, such as error correction, memory refresh operations, and power management of the memory 104.

In some implementations of the computing system 100, the computing system 100 also includes baseboard management controller (BMC) circuitry 108. The BMC circuitry 108 enables remote management of the computing system 100. The BMC circuitry 108 may share the baseboard 101 with at least one of the one or more processors 102. The BMC circuitry 108 is a specialized service processor that remotely monitors the physical state of the computing system 100. For instance, such implementations may be suitable when the computing system 100 includes a network-connected desktop computer/workstation, a network server, and/or other network-connected hardware device.

The BMC circuitry 108 performs hardware monitoring. For instance, the BMC circuitry 108 may include sensors that measure internal and/or external physical variables, such as temperature, humidity, power supply voltage, fan speeds, communications parameters, other variables, or any combination of these variables. When one of these variables crosses a threshold outside of specified limits, the BMC circuitry 108 may instruct the one or more processors 102 and/or other hardware to make a remedial action to correct for operation outside of the specified limits. For instance, the BMC circuitry 108 may instruct the one or more processors 102 to turn off and/or reboot the computing system 100, adjust operation to reduce thermal generation by reducing at least one performance characteristic, flash the BIOS 105, and/or any other remedial actions that may be appropriate based on measurements. In some situations, the BMC circuitry 108 may raise an alarm, log an event, and/or send an alert to a system administrator when such remedial actions are to be taken.

In some implementations, the BMC circuitry 108 may include and/or interface with a complex programmable logic device (CPLD) 110. The CPLD 110 may be a programmable logic device that may include on-board non-volatile configuration memory that enables the CPLD 110 to function on startup of the computing system 100 without external configuration being loaded into the CPLD 110 from an external configuration memory. This immediate availability enables the CPLD 110 to be used for boot loader functions before handing over control to other devices that do not have their own non-volatile memory storage. For instance, the CPLD 110 may be used to load configuration data for another programmable logic device, such as an FPGA or one or more of the one or more processors 102. In some implementations, the CPLD 110 may be used to exchange data between the BMC circuitry 108 and the memory 104 and/or the processor(s) 102 either directly or through the memory controller 106. Additionally or alternatively, the CPLD 110 may be used to manage power distribution to the memory 104, the memory controller 106, the one or more processors 102, and/or other portions of the BMC circuitry 108 and/or the computing system 100.

As previously noted, communications through some interfaces, such as IPMI and/or via a VNIC or CHIF may be limited in security and/or throughput. To enable the BMC circuitry 108 to communicate with the one or more processors 102 in systems at scale, the BMC circuitry 108 may include shared memory 112 that is a shared memory region that is shared between the one or more processors 102 and the BMC circuitry 108 using a secure link 114. For instance, the shared memory 112 and its related secure link 114 may use a Compute Express Link (CXL) protocol to enable the BMC circuitry 108 and the one or more processors 102 to access a shared memory region that is used to exchange data securely in a low-latency manner. For instance, the shared memory 112 may be a Type 1 device to coherently access CPU memory, a Type 2 device to coherently access memory of at least one of the one or more processors 102 and/or device (e.g., BMC circuitry 108) from the device and the one or more processors 102, and/or a Type 3 device to allow at least one of the one or more processors 102 to access memory of an attached memory device (e.g., in the BMC circuitry 108 or otherwise attached to the baseboard 101).

The shared memory 112 and its related secure link 114 are part of a connection that may be used in a variety of use cases that use secure low-latency transfers. For instance, this connection may be used to exchange data between the BMC circuitry 108 and the BIOS 105, exchange data between the one or more processor 102 and the BMC circuitry 108 for telemetry, perform post-package repair, remotely share secure data (e.g., AI models) to the one or more processors 102 through the BMC circuitry 108, and/or any other situations where data is to be remotely shared with the one or more processors 102 via the BMC circuitry 108.

The BMC circuitry 108 may receive information from and/or transmit information to the computing system 100 via a universal asynchronous receiver/transmitter (UART) 116. The UART 116 is a hardware protocol that allows devices to exchange serial data to send and/or receive data through a peripheral component interconnect express (PCIe) interface 118 and/or an Ethernet interface 122 that may be used to couple the baseboard 101 to other components, such as expansion cards.

Additionally or alternatively, the BMC circuitry 108 may receive information from and/or transmit information to the computing system 100 via a serial peripheral interface (SPI) 120. The SPI 120 may enable the BMC circuitry 108 to connect to peripheral devices such as sensors and/or memory chips. Additionally or alternatively, the BMC circuitry 108 may use an Ethernet controller chip via the SPI 120 to transmit information using an Ethernet interface 122 or directly transfer information using the Ethernet interface 122.

The computing system 100 may further include a power distribution unit (PDU) 124 that may be a hardware device coupled to the BMC circuitry 108 that is used to distribute electric power to one or more baseboards 101 and their connected components, such as the one or more processors 102, the memory 104, the memory controller 106, and/or the BMC circuitry 108. The BMC circuitry 108 may communicate with the PDU 124 to obtain various parameters, such as power consumed, etc. Furthermore, the BMC circuitry 108 may send commands to the PDU 124 to control operation of the computing system 100. For instance, the BMC circuitry 108 may use the PDU 124 to cause the computing system 100 to shut down or change modes (e.g., change to or from a power savings mode).

The computing system 100 may also include a cooling system 126 that tracks thermal conditions of the computing system 100. The cooling system 126 may also include cooling devices, such as fans or pumps, which are used to move fluid (e.g., air or liquid) to control how much thermal energy the computing system 100 may dissipate. The BMC circuitry 108 may receive the monitored thermal conditions and change operation of the cooling system 126 accordingly. For instance, the BMC circuitry 108 may cause a fan or pump speed to increase in response to a temperature increase. Additionally or alternatively, the BMC circuitry 108 may receive instructions from a remote electronic device to cause the computing system 100 to shut down in response to thermal and/or power conditions.

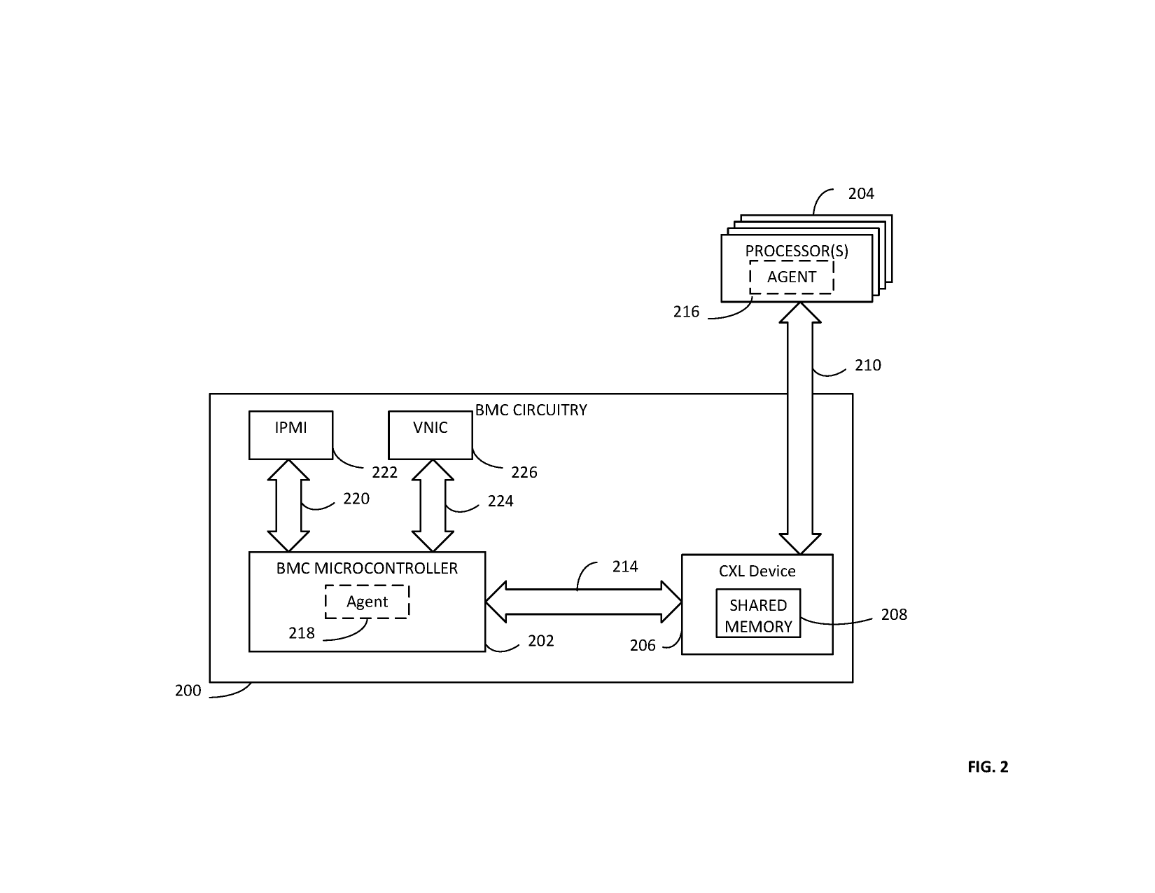

FIG. 2 is a block diagram of BMC circuitry 200. For example, some implementations of the BMC circuitry 200 may be similar to the BMC circuitry 108 of FIG. 1. The BMC circuitry 200 enables remote management of a computing system in which the BMC circuitry 200 is located. The BMC circuitry 200 includes a BMC microcontroller 202 that is a specialized service microcontroller/processor that monitors the physical state of the computing system and provides a mechanism for remotely sharing data and receiving commands from remote devices.

The BMC circuitry 200 may share a baseboard with at least one of the one or more processors 204 of the computing system in which the BMC circuitry 200 is located. The one or more processors 204 may include one or more processing resources, such as a central processing unit (CPU), a graphics processing unit (GPU), implemented using a field programmable gate array (FPGA), or a combination thereof. The one or more processors 204 may implement various stored programs. Accordingly, the computing system 100 may include any suitable computing devices that may utilize one or more processors 102, such as servers, desktop computers, laptop computers, tablet computers, cellular devices, wearable devices, and/or other computing devices.

The BMC circuitry 200 includes an onboard CXL device 206 that includes shared memory 208 that provides a communication path between the one or more processors 204 and the BMC microcontroller 202. The onboard CXL device 206 may be mounted to the same baseboard to which the BMC circuitry 200 and at least one of the one or more processors 204 are connected.

The CXL device 206 provides a CXL port 210 that exposes the shared memory 208 of the CXL device 206 to the one or more processors 204. For instance, the CXL port 210 may be implemented using a PCIe connector that is part of a PCIe (e.g., PCIe 5.0) or other bus interface physical layer infrastructure and may support plug-and-play interoperability between the one or more processors 204 and the CXL device 206. To provide such interaction between the one or more processors 204, the CXL device 206 follows a CXL.io sub-protocol to initialize a connection and link with the one or more processors 204 via the CXL port 210. The CXL.io sub-protocol may also provide device discovery and register access similar to PCIe protocols. In some implementations, the CXL device 206 may also follow a CXL.cache sub-protocol to allow other devices (e.g., the BMC microcontroller 202) to securely access memory of the host (e.g., one or more processors 204) with low latency via the CXL port 210. Additionally or alternatively, the CXL device 206 may follow a CXL.memory sub-protocol that enables the host to access device-attached memory (e.g., the shared memory 208) via the CXL port 210.

The CXL device 206 provides a CXL port 214 that exposes the shared memory 208 of the CXL device 206 to the BMC microcontroller 202. For instance, the CXL port 214 may be implemented using a PCIe connector that is part of a PCIe (e.g., PCIe 5.0) physical layer infrastructure and may support plug-and-play interoperability between the BMC microcontroller 202 and the CXL device 206. To provide such interaction between the BMC microcontroller 202, the CXL device 206 follows a CXL.io sub-protocol to initialize a connection and link with the BMC microcontroller 202 via the CXL port 214. In some implementations, the CXL device 206 may also follow a CXL.cache sub-protocol to allow other devices (e.g., the one or more processors 204) to securely access memory of the BMC microcontroller 202 with low latency via the CXL port 214. Additionally or alternatively, the CXL device 206 may follow a CXL.memory sub-protocol that enables the host to access device-attached memory (e.g., the shared memory 208) via the CXL port 214.

Using the CXL ports 210 and 214, the CXL device 206 uses the shared memory 208 to provide a secure, low-latency communication path between the BMC microcontroller 202 and the one or more processors 204. Specifically, the BMC microcontroller 202 and the one or more processors 204 may write data to the shared memory 208 to exchange such data between each other. The host (e.g., one or more processors 204) and the BMC microcontroller 202 each use hardware atomics implemented via the CXL.io sub-protocol to use the shared memory 208 as memory-mapped I/O (MMIO) between the one or more processors 204 and the BMC microcontroller 202. The hardware atomics may include a test-and-set instruction, a compare-and-swap instruction, or other atomics. A test-and-set instruction is used to write (or set) a bit (e.g., 1) to a memory location in the shared memory 208 and return its old value as a single atomic. A compare-and-swap instruction is an atomic instruction used in multithreading by comparing the contents of a memory location in the shared memory 208 and overwriting the contents at the memory location to a new value when the contents match.

The CXL device 206 may provide security for shared data between the BMC microcontroller 202 and the one or more processors 204 by using CXL protocols to implement fabric management in the MMIO space. The CXL device 206 uses this fabric management to ensure that only the BMC microcontroller 202 and the one or more processors 204 have access to a particular CXL MMIO region of the shared memory 208.

In some implementations, the shared memory 208 may be secured further. For instance, the contents of the shared memory 208 may be encrypted using keys that are shared only between identified applications running on the one or more processors 204 and the BMC microcontroller 202. For instance, the running applications may include an agent 216 running on the one or more processors 204 and/or an agent 218 running on the BMC microcontroller 202. In some implementations, the encryption may be performed differently for different regions and/or applications to provide greater granularity for better security with increased resource consumption.

This secure and low-latency communication between the one or more processors 204 and the BMC microcontroller 202 may be used to ensure efficient and reliable management of a server’s hardware and firmware. This exchanged data may include AI models, BIOS/UEFI variables, telemetry data, and/or any other suitable data.

Although the CXL ports 210 and 214 provide a communication pathway between the BMC microcontroller 202 and the one or more processors 204, some implementations of the BMC circuitry 200 may have other communication pathways. For instance, the BMC circuitry 200 may include a port 220 implemented via an Intelligent Platform Management Interface (IPMI) 222 or CHIF to provide an interface with the BMC microcontroller 202. The IPMI 222 may enable the BMC microcontroller 202 to communicate with other devices, such as the one or more processors 204 and/or other remote processors.

Additionally or alternatively, the BMC circuitry 200 may include a port 224 that is implemented using a virtual network interface card (VNIC) 226. The VNIC 226 may be a virtual USB NIC exposed by the BMC circuitry 200 to the operating system of the one or more processors 204.

These non-CXL-based communication pathways, such as the port 220 and/or the port 224, may be used to exchange data at lower speeds as a default communication path between the one or more processors 204 and the BMC microcontroller 202 while bypassing the shared memory 208. For instance, when communications are below a threshold level, these non-CXL-based communication pathways may be used, but these non-CXL-based communication pathways may become insufficient for some data (e.g., AI models, telemetry data, etc.) that is large. Thus, when the bandwidth consumed and/or an amount of data sent is above a threshold, the BMC microcontroller 202 may switch to using the shared memory 208 to exchange data. Additionally or alternatively, the BMC microcontroller 202 may send data (e.g., AI models) that users may want to secure. Moreover, the non-CXL-based communication pathways and/or CXL-based communication pathways may be used to exchange keys used to encrypt data exchanged via the shared memory 208.

The adaptive switchover from non-CXL-based management channels to CXL-based management channels may occur when some change occurs that impacts which channel should be used. For example, the switchover may occur when a frequency of transmission of telemetry data is to be increased, when data is to be secured, when an amount of data is to exceed a threshold available via the non-CXL-based management channels, and/or any other reasons to use the shared memory 208 instead of non-CXL-based management channels.

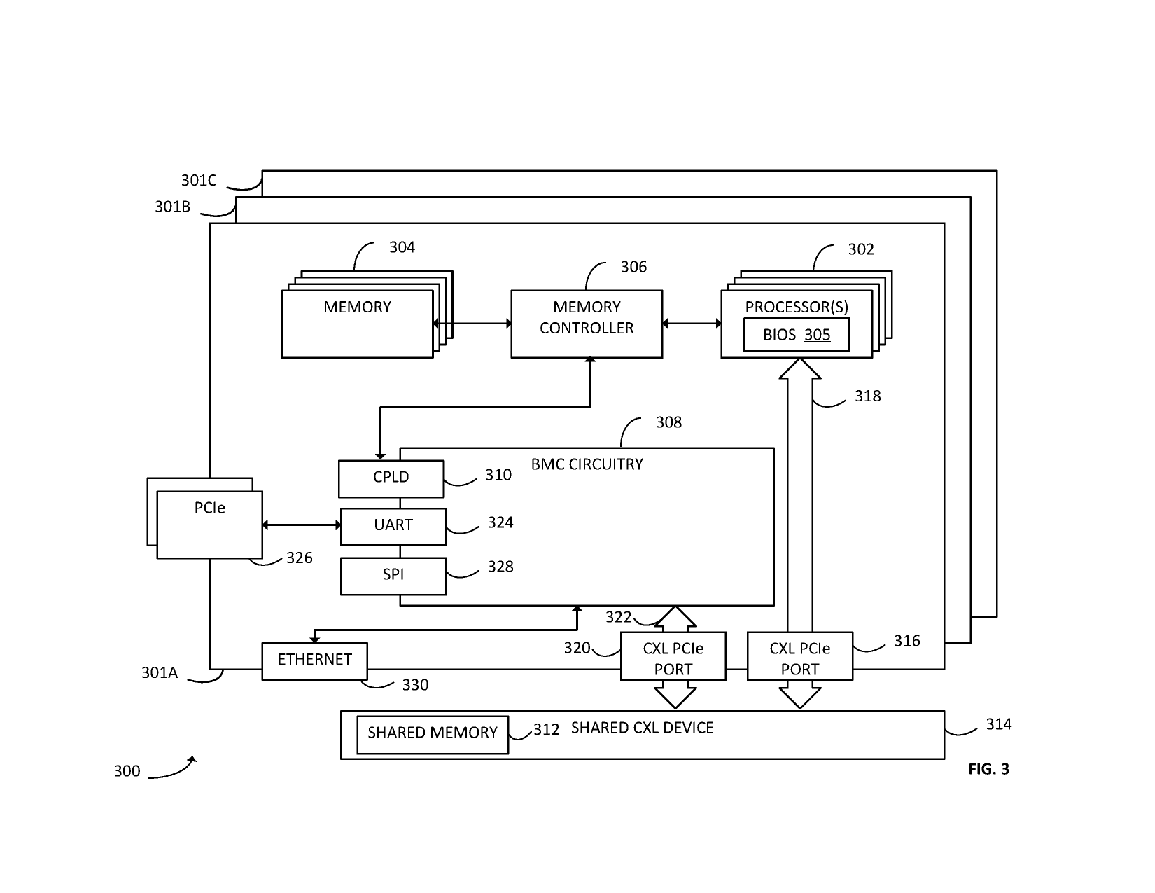

FIG. 3 is a diagram, illustrating a computing system 300 that includes multiple baseboards 301A, 301B, and 301C (collectively referred to as baseboards 301). As such, the computing system 300 may include a scalable system (e.g., a server) that may have multiple partitions or customers (npars) implemented using the baseboards 301. Each of the baseboards 301 has one or more processors 302 coupled to it. The one or more processors 302 may include one or more processing resources, such as a central processing unit (CPU), a graphics processing unit (GPU), implemented using a field programmable gate array (FPGA), or a combination thereof. The one or more processors 302 may implement various stored programs.

Such programs or instructions executed by the one or more processors 302 may be stored in any suitable article of manufacture that includes one or more non-transitory and computer-readable media at least collectively storing the instructions or routines. For instance, the instructions may be stored in a memory 304 of one or more of the baseboards 301 of the computing system 300. Additionally or alternatively, the memory 304 may be separate from and external to the baseboards 301. Thus, the memory 304 may be mounted on and/or coupled to any of the baseboards 301. The memory 304 may include any suitable articles of manufacture suitable for storing data and/or executable instructions that may be executed by the one or more processors 302. The memory 304 may include any suitable memory devices, such as random-access memory (RAM), including but not limited to, double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof. The memory 304 may include one or more different memory devices. Additionally or alternatively, the memory 304 may include a storage device, such as a Non-Volatile Memory Express (NVMe) device, a hard disk drive (HDD), a solid-state drive (SSD), an optical drive, another type of storage device, flash memory, read-only memory (ROM), or any combination thereof.

Programs encoded on such a computer program product of the articles of manufacture may also include instructions that may be executed by the one or more processors 302 to enable the computing system 300 to provide various functionalities. For instance, the programs implemented by the one or more processors 302 using the instructions stored on the non-transitory, computer-readable medium of the memory 304 may include a Basic Input/Output System (BIOS) 305 that is a type of firmware that may be stored on the baseboard 101, may perform a Power-On Self-Test (POST) to check that devices are functioning properly, configure hardware of the computing system 300, may load an operating system (OS), and manage data flow between the OS and connected devices of the computing system. The OS, once loaded into the one or more processors 302 by the BIOS 305, manages all other application programs and manages device hardware (e.g., the memory 304) and software resources. In some implementations, the computing system 300 may include a Unified Extensible Firmware Interface (UEFI) in place of the BIOS 305.

To facilitate control of the memory 304 and/or exchange of data between the one or more processors 302 and the memory 304, the computing system 300 includes a memory controller 306. The memory controller 306 may be a hardware and/or software component that connects one or more diverse types of memory in the memory 304 to the one or more processors 302 (e.g., via a processor bus of the one or more processors 302). The memory controller 306 may be part of the one or more processors 302 and/or may be implemented on a separate chip mounted on a baseboard 301 of the computing system. The memory controller 306 manages data flow between the memory 304 and the one or more processors 302 including memory read and write operations. During a power up of the computing system 300, the memory controller 306 configures and enables use of specific memory devices of the memory 304. Additionally, the memory controller 306 may handle various functions, such as error correction, memory refresh operations, and power management of the memory 304.

The computing system 300 also includes baseboard management controller (BMC) circuitry 308 on at least one of the baseboards 301. The BMC circuitry 308 enables remote management of the computing system 300. The BMC circuitry 308 may share the baseboard 301 with at least one of the one or more processors 302. The BMC circuitry 308 is a specialized service processor/microcontroller that remotely monitors the physical state of the computing system 300. For instance, such implementations may be suitable when the computing system 300 includes a network-connected desktop computer/workstation, a network server, and/or other network-connected hardware device.

The BMC circuitry 308 performs hardware monitoring. For instance, the BMC circuitry 308 may include sensors that measure internal and/or external physical variables, such as temperature, humidity, power supply voltage, fan speeds, communications parameters, other variables, or any combination of these variables. When one of these variables crosses a threshold outside of specified limits, the BMC circuitry 308 may instruct the one or more processors 302 and/or other hardware to make a remedial action to correct for operation outside of the specified limits. For instance, the BMC circuitry 308 may instruct the one or more processors 302 to turn off and/or reboot the computing system 300, adjust operation to reduce thermal generation by reducing at least one performance characteristic, flash the BIOS 305, and/or any other remedial actions that may be appropriate based on measurements. In some situations, the BMC circuitry 308 may raise an alarm, log an event, and/or send an alert to a system administrator when such remedial actions are to be taken.

In some implementations, the BMC circuitry 308 may include and/or interface with a complex programmable logic device (CPLD) 310. The CPLD 310 may be a programmable logic device that may include on-board non-volatile configuration memory that enables the CPLD 310 to function on startup of the computing system 300 without external configuration being loaded into the CPLD 310 from an external configuration memory. This immediate availability enables the CPLD 310 to be used for boot loader functions before handing over control to other devices that do not have their own non-volatile memory storage. For instance, the CPLD 310 may be used to load configuration data for another programmable logic device, such as an FPGA or one or more of the one or more processors 302. In some implementations, the CPLD 310 may be used to exchange data between the BMC circuitry 308 and the memory 304 and/or the processor(s) 302 either directly or through the memory controller 306. Additionally or alternatively, the CPLD 310 may be used to manage power distribution to the memory 304, the memory controller 306, the one or more processors 302, and/or other portions of the BMC circuitry 308 and/or the computing system 300.

To enable the BMC circuitry 308 to communicate with the one or more processors 302, the computing system 300 may use shared memory 312 that is part of a shared CXL device 314. For instance, the shared CXL device 314 may be a device external to the baseboards 301 that is shared by the baseboards 301. For instance, the shared CXL device 314 may be a top-of-rack (TOR) switch that connects to each of the baseboards 301.

The shared memory 312 includes a shared memory region that is shared between the one or more processors 302 and the BMC circuitry 308 using respective CXL PCIe ports implementing a corresponding secure link. For instance, the shared CXL device 314 may use a first CXL PCIe port 316 to implement a first secure link 318 between the shared memory 312 and the one or more processors 302. Likewise, the shared CXL device 314 may use a second CXL PCIe port 320 to implement a second secure link 322 between the shared memory 312 and the BMC circuitry 308, such as a BMC microcontroller of the BMC circuitry 308.

These links may use a Compute Express Link (CXL) protocol to enable the BMC circuitry 308 and the one or more processors 302 to access a shared memory region that is used to exchange data securely in a low-latency manner. For instance, the shared CXL device 314 may be a Type 1 device to coherently access CPU memory, a Type 2 device to coherently access memory of at least one of the one or more processors 302 and/or device (e.g., BMC circuitry 308) from the device and the one or more processors 302, and/or a Type 3 device to allow at least one of the one or more processors 302 to access memory of an attached memory device (e.g., in the BMC circuitry 308 or otherwise attached to the baseboards 301).

The shared CXL device 314 provides the first CXL PCIe port 316 that exposes the shared memory 312 of the shared CXL device 314 to the one or more processors 302. For instance, the PCIe CXL port 316 may be implemented using a PCIe connector that is part of a PCIe (e.g., PCIe 5.0) physical layer infrastructure and may support plug-and-play interoperability between the one or more processors 302 and the shared CXL device 314. To provide such interaction between the one or more processors 302, the shared CXL device 314 follows a CXL.io sub-protocol to initialize a connection and link with the one or more processors 302 via the first PCIe CXL port 316. The CXL.io sub-protocol may also provide device discovery and register access similar to PCIe protocols. In some implementations, the shared CXL device 314 may also follow a CXL.cache sub-protocol to allow other devices (e.g., the BMC circuitry 308) to securely access memory of the host (e.g., one or more processors 302) with low latency via the first PCIe CXL port 316. Additionally or alternatively, the shared CXL device 314 may follow a CXL.memory sub-protocol that enables the host to access device-attached memory (e.g., the shared memory 312) via the first PCIe CXL port 316.

The shared CXL device 314 provides a second PCIe CXL port 320 that exposes the shared memory 312 of the shared CXL device 314 to the BMC circuitry 308. For instance, the second PCIe CXL port 320 may be implemented using a PCIe connector that is part of a PCIe (e.g., PCIe 5.0) physical layer infrastructure and may support plug-and-play interoperability between the BMC circuitry 308 and the shared CXL device 314. To provide such interaction between the BMC circuitry 308, the shared CXL device 314 follows a CXL.io sub-protocol to initialize a connection and link with the BMC circuitry 308 via the second PCIe CXL port 320. In some implementations, the shared CXL device 314 may also follow a CXL.cache sub-protocol to allow other devices (e.g., the one or more processors 302) to securely access memory of the BMC circuitry 308 (e.g., to its microcontroller) with low latency via the second PCIe CXL port 320. Additionally or alternatively, the shared CXL device 314 may follow a CXL.memory sub-protocol that enables the host to access device-attached memory (e.g., the shared memory 208) via the second PCIe CXL port 320.

Each baseboard 301 may have one or more such secure links to the shared memory 312 via the shared CXL device 314. For instance, if only one baseboard 301 (e.g., baseboard 301A) has BMC circuitry 308, the remaining baseboards 301 may still use respective secure links to respective one or more processors 302. However, if multiple baseboards 301 include respective BMC circuitries 308 and one or more processors 302, they may have multiple such secure links. In certain embodiments, each of such links may be implemented using a single shared space in the shared memory 312. Additionally or alternatively, the shared memory 312 may partition different shared memory on a baseboard 301 granularity with each baseboard having its own space accessible by its respective one or more processors 302 and corresponding BMC circuitry 308.

By providing secure, low-latency connections, the computing system 300 enables each of the baseboards 301 to send relatively large amounts of data (e.g., telemetry data) to one or more BMC circuitries 308 without fully consuming available bandwidth. By leaving some resources unconsumed, such secure links may leave resources for use by important features such as hardware error monitoring. In other words, despite telemetry collection and processing being somewhat resource intensive, the core features of the BMC circuitry 308 may be relatively unimpeded.

Furthermore, these secure links may be used to propagate an indication of error from one chassis to another in an npar architecture. In other words, the secure CXL links may be used to share device error information between different BMC circuitries 308 of the computing system 300.

The BMC circuitry 308 may receive information from and/or transmit information to the computing system 300 via a universal asynchronous receiver/transmitter (UART) 324. The UART 324 is a hardware protocol that allows devices to exchange serial data to send and/or receive data through a peripheral component interconnect express (PCIe) interface 326 and/or an Ethernet interface 330 that may be used to couple the baseboard 301 to other components, such as expansion cards. This PCIe interface 326 may be the same PCIe interface used to implement the CXL PCIe ports 316 and 320 or may be separate PCIe interfaces.

Additionally or alternatively, the BMC circuitry 308 may receive information from and/or transmit information to the computing system 300 via a serial peripheral interface (SPI) 328. The SPI 328 may enable the BMC circuitry 308 to connect to peripheral devices such as sensors and/or memory chips. Additionally or alternatively, the BMC circuitry 308 may use an Ethernet controller chip via the SPI 328 to transfer information using the Ethernet interface 330 or directly transfer information using the Ethernet interface 330.

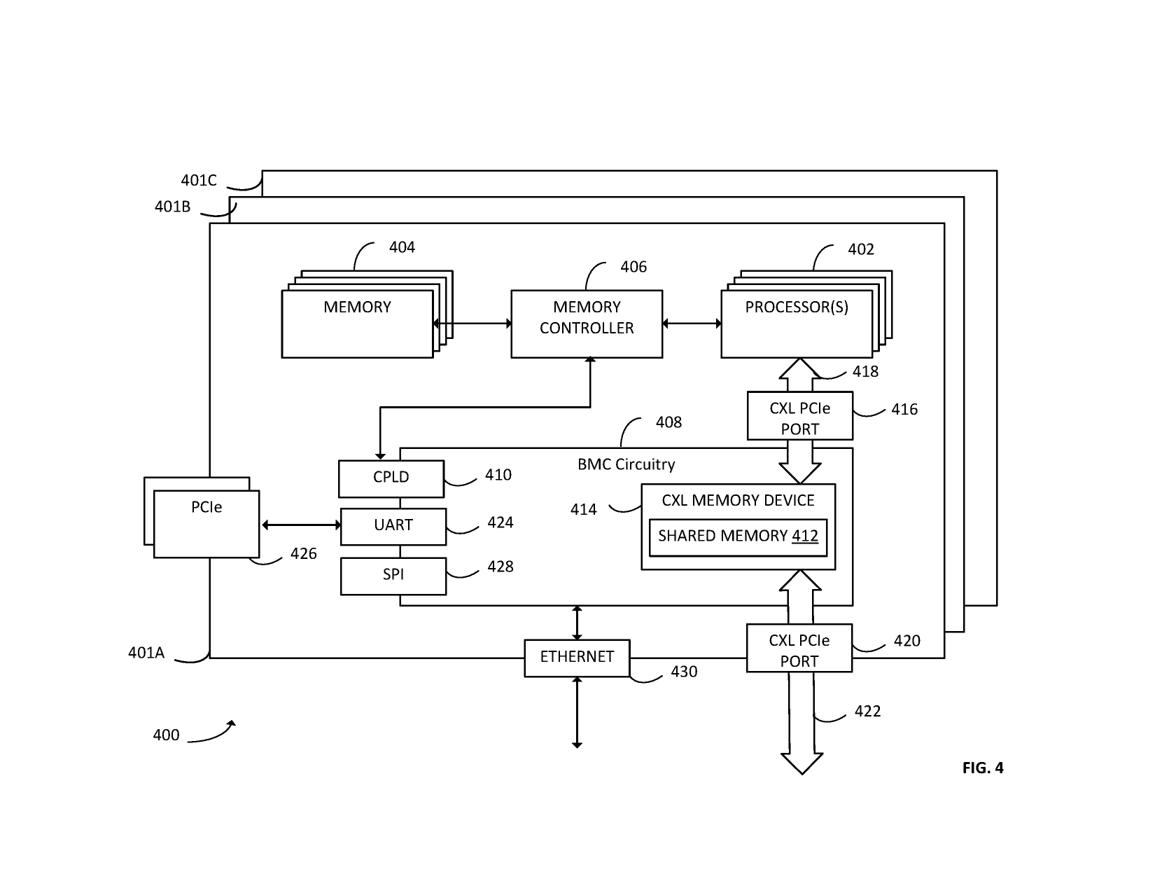

FIG. 4 is a diagram, illustrating a computing system 400 that includes multiple baseboards 401A, 401B, and 401C (collectively referred to as baseboards 401). As such, the computing system 400 may include a scalable system (e.g., a server) that may have multiple partitions or customers (npars) implemented using the baseboards 401. Each of the baseboards 401 has one or more processors 402 coupled to it. The one or more processors 402 may include one or more processing resources, such as a central processing unit (CPU), a graphics processing unit (GPU), implemented using a field programmable gate array (FPGA), or a combination thereof. The one or more processors 402 may implement various stored programs.

Such programs or instructions executed by the one or more processors 402 may be stored in any suitable article of manufacture that includes one or more non-transitory and computer-readable media at least collectively storing the instructions or routines. For instance, the instructions may be stored in a memory 404 of one or more of the baseboards 401 of the computing system 400. Additionally or alternatively, the memory 404 may be separate from and external to the baseboards 401. Thus, the memory 404 may be mounted on and/or coupled to any of the baseboards 401. The memory 404 may include any suitable articles of manufacture suitable for storing data and/or executable instructions that may be executed by the one or more processors 402. The memory 404 may include any suitable memory devices, such as random-access memory (RAM), including but not limited to, double data rate type 5 (DDR5) synchronous dynamic random-access memory (SDRAM), double data rate type 4 (DDR4) SDRAM, low-power double data rate (LPDDR) SDRAM, another suitable type of memory device, or any combination thereof. The memory 404 may include one or more different memory devices. Additionally or alternatively, the memory 404 may include a storage device, such as a Non-Volatile Memory Express (NVMe) device, a hard disk drive (HDD), a solid-state drive (SSD), an optical drive, another type of storage device, flash memory, read-only memory (ROM), or any combination thereof.

Programs encoded on such a computer program product of the articles of manufacture may also include instructions that may be executed by the one or more processors 402 to enable the computing system 400 to provide various functionalities. For instance, the programs implemented by the one or more processors 402 using the instructions stored on the non-transitory, computer-readable medium of the memory 404 may include a Basic Input/Output System (BIOS) 405 that is a type of firmware that may be stored on the baseboard 401, may perform a Power-On Self-Test (POST) to check that devices are functioning properly, configure hardware of the computing system 400, may load an operating system (OS), and manage data flow between the OS and connected devices of the computing system. The OS, once loaded into the one or more processors 402 by the BIOS 405, manages all other application programs and manages device hardware (e.g., the memory 404) and software resources. In some implementations, the computing system 400 may include a Unified Extensible Firmware Interface (UEFI) in place of the BIOS 405.

To facilitate control of the memory 404 and/or exchange of data between the one or more processors 402 and the memory 404, the computing system 400 includes a memory controller 406. The memory controller 406 may be a hardware and/or software component that connects one or more different types of memory in the memory 404 to the one or more processors 402 (e.g., via a processor bus of the one or more processors 402). The memory controller 406 may be part of the one or more processors 402 and/or may be implemented on a separate chip mounted on a baseboard 401 of the computing system. The memory controller 406 manages data flow between the memory 404 and the one or more processors 402 including memory read and write operations. During a power up of the computing system 400, the memory controller 406 configures and enables use of specific memory devices of the memory 404. Additionally, the memory controller 406 may handle various functions, such as error correction, memory refresh operations, and power management of the memory 404.

The computing system 400 also includes baseboard management controller (BMC) circuitry 408 on at least one of the baseboards 401. The BMC circuitry 408 enables remote management of the computing system 400. The BMC circuitry 408 may share the baseboard 401 with at least one of the one or more processors 402. The BMC circuitry 408 is a specialized service processor/microcontroller that remotely monitors the physical state of the computing system 400. For instance, such implementations may be suitable when the computing system 400 includes a network-connected desktop computer/workstation, a network server, and/or other network-connected hardware device.

The BMC circuitry 408 performs hardware monitoring. For instance, the BMC circuitry 408 may include sensors that measure internal and/or external physical variables, such as temperature, humidity, power supply voltage, fan speeds, communications parameters, other variables, or any combination of these variables. When one of these variables crosses a threshold outside of specified limits, the BMC circuitry 408 may instruct the one or more processors 402 and/or other hardware to make a remedial action to correct for operation outside of the specified limits. For instance, the BMC circuitry 408 may instruct the one or more processors 402 to turn off and/or reboot the computing system 400, adjust operation to reduce thermal generation by reducing at least one performance characteristic, flash the BIOS 405, and/or any other remedial actions that may be appropriate based on measurements. In some situations, the BMC circuitry 408 may raise an alarm, log an event, and/or send an alert to a system administrator when such remedial actions are to be taken.

In some implementations, the BMC circuitry 408 may include and/or interface with a complex programmable logic device (CPLD) 410. The CPLD 410 may be a programmable logic device that may include on-board non-volatile configuration memory that enables the CPLD 410 to function on startup of the computing system 400 without external configuration being loaded into the CPLD 410 from an external configuration memory. This immediate availability enables the CPLD 410 to be used for boot loader functions before handing over control to other devices that do not have their own non-volatile memory storage. For instance, the CPLD 410 may be used to load configuration data for another programmable logic device, such as an FPGA or one or more of the one or more processors 402. In some implementations, the CPLD 410 may be used to exchange data between the BMC circuitry 408 and the memory 404 and/or the processor(s) 402 either directly or through the memory controller 406. Additionally or alternatively, the CPLD 410 may be used to manage power distribution to the memory 404, the memory controller 406, the one or more processors 402, and/or other portions of the BMC circuitry 408 and/or the computing system 400.

To enable the BMC circuitry 408 to communicate with the one or more processors 402, the computing system 400 may use shared memory 412 that is part of a CXL memory device 412. For instance, the CXL memory device 414 may be a device that is mounted to one of the baseboards 401 (e.g., baseboard 401A) that is shared by other baseboards 401 in a chassis.

The shared memory 412 includes a shared memory region that is shared between the one or more processors 402 and the BMC circuitry 408 using respective CXL PCIe ports implementing a corresponding secure link. For instance, the CXL memory device 414 may use a first CXL PCIe port 416 to implement a first secure link 418 between the shared memory 412 and the one or more processors 402. Likewise, the CXL memory device 414 may use a second CXL PCIe port 420 to implement a second secure link 422 between the shared memory 412 one or more processors of other baseboards 301. Moreover, the shared memory 412 may provide a secure link via an additional port to other parts of the BMC circuitry 408, such as a BMC microcontroller of the BMC circuitry 408. For instance, such microcontroller linkage may be implemented similar to the link of the CXL port 214 of the BMC circuitry 200.

These links may use a Compute Express Link (CXL) protocol to enable the BMC circuitry 408 and the one or more processors 402 to access a shared memory region that is used to exchange data securely in a low-latency manner. For instance, the CXL memory device 412 may be a Type 1 device to coherently access CPU memory, a Type 2 device to coherently access memory of at least one of the one or more processors 402 and/or device (e.g., BMC circuitry 408) from the device and the one or more processors 402, and/or a Type 3 device to allow at least one of the one or more processors 402 to access memory of an attached memory device (e.g., in the BMC circuitry 408 or otherwise attached to the baseboards 401).

The CXL memory device 414 provides the first CXL PCIe port 416 that exposes the shared memory 412 of the CXL memory device 414 to the one or more processors 402 of the baseboard 401A. For instance, the PCIe CXL port 416 may be implemented using a PCIe connector that is part of a PCIe (e.g., PCIe 5.0) physical layer infrastructure and may support plug-and-play interoperability between the one or more processors 402 and the CXL memory device 414. To provide such interaction between the one or more processors 402, the CXL memory device 414 follows a CXL.io sub-protocol to initialize a connection and link with the one or more processors 402 via the first PCIe CXL port 416. The CXL.io sub-protocol may also provide device discovery and register access similar to PCIe protocols. In some implementations, the CXL memory device 414 may also follow a CXL.cache sub-protocol to allow other devices (e.g., the BMC circuitry 408) to securely access memory of the host (e.g., one or more processors 402) with low latency via the first PCIe CXL port 416. Additionally or alternatively, the CXL memory device 414 may follow a CXL.memory sub-protocol that enables the host to access device-attached memory (e.g., the shared memory 412) via the first PCIe CXL port 416.

The CXL memory device 414 provides a second PCIe CXL port 420 that exposes the shared memory 412 of the CXL memory device 414 to the processors of other baseboards 401. For instance, the second PCIe CXL port 420 may be implemented using a PCIe connector that is part of a PCIe (e.g., PCIe 5.0) or other physical layer infrastructure and may support plug-and-play interoperability between the baseboards 401. In other words, each baseboard 401 may have one or more such secure links to the shared memory 412 via the CXL memory device 414 to enable each of the baseboards 401 to share the BMC circuitry 408. In certain embodiments, each of such links may be implemented using a single shared space in the shared memory 412. Additionally or alternatively, the shared memory 412 may partition different shared memory on a baseboard 401 granularity with each baseboard having its own space accessible by its respective one or more processors 402 of each of the baseboards 401 and the BMC circuitry 408.

By providing secure, low-latency connections, the computing system 400 enables each of the baseboards 401 to send relatively large amounts of data (e.g., telemetry data) to the BMC circuitry 408 without fully consuming available bandwidth. By leaving some resources unconsumed, such secure links may leave resources for use by important features such as hardware error monitoring. In other words, despite telemetry collection and processing being somewhat resource intensive, the core features of the BMC circuitry 408 may be relatively unimpeded.

The BMC circuitry 408 may receive information from and/or transmit information to the computing system 400 via a universal asynchronous receiver/transmitter (UART) 424. The UART 424 is a hardware protocol that allows devices to exchange serial data to send and/or receive data through a peripheral component interconnect express (PCIe) interface 426 and/or an Ethernet interface 430 that may be used to couple the baseboard 401 to other components, such as expansion cards. This PCIe interface 426 may be the same PCIe interface used to implement the CXL PCIe ports 416 and 420 or may be separate PCIe interfaces.

Additionally or alternatively, the BMC circuitry 408 may receive information from and/or transmit information to the computing system 400 via a serial peripheral interface (SPI) 428. The SPI 428 may enable the BMC circuitry 408 to connect to peripheral devices such as sensors and/or memory chips. Additionally or alternatively, the BMC circuitry 408 may use an Ethernet controller chip via the SPI 428 to transfer information using the Ethernet interface 430 or directly transfer information using the Ethernet interface 430.

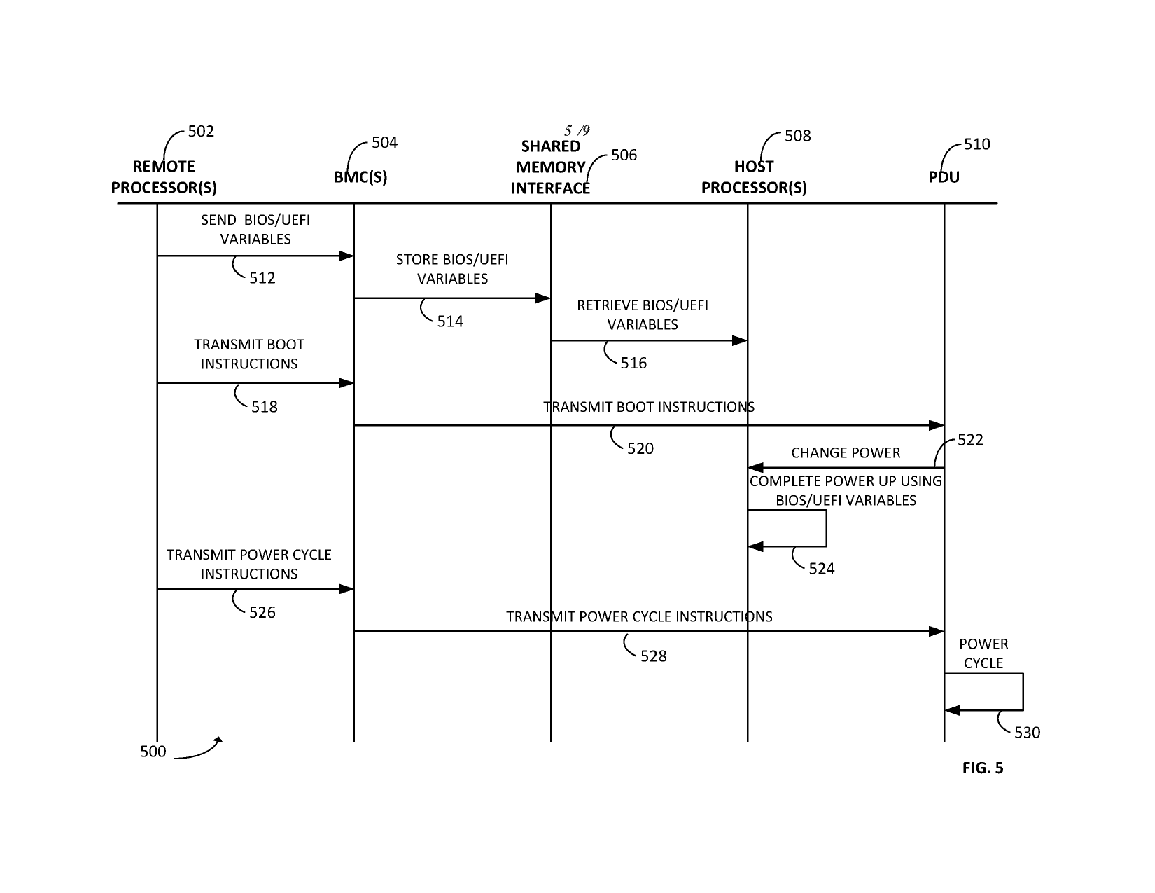

FIG. 5 is a sequence diagram of a process 500 that utilizes a shared memory to remotely store BIOS or UEFI variable through a BMC. As illustrated, the process 500 utilizes remote processor(s) 502, baseboard management controller(s) (BMC(s)) 504, a shared memory interface 506, host processor(s) 508, and a power distribution unit (PDU) 510.

The remote processor(s) 502 may be similar to any of the processors 102, 204, 302, and/or 402. The remote processor(s) 502 may couple to the BMC(s) 504 to remotely manage computing systems, such as the computing system 100, the computing system 300, and/or the computing system 400.

The BMC(s) 504 may include BMC circuitry suitable to enable remote management of a host device (e.g., a server) including the host processor(s) 508. For instance, the BMC(s) 504 may include a suitable architecture, such as architectures discussed in relation to the BMC circuitry 108, 200, 308, or 408. The BMC(s) 504 include components to complete such management. For instance, the BMC(s) 504 may include one or more BMC microcontrollers, such as the BMC microcontroller 202.

The shared memory interface 506 includes a shared memory that is exposed to the BMC(s) 504 and the host processor(s) 508 to provide an interface between the BMC(s) 504 and the host processor(s) 508. The shared memory of the shared memory interface 506 may include a suitable memory type, such as those discussed in relation to the shared memory 112, 208, 312, and/or 412. The shared memory interface 506 may include suitable underlying interfaces. For example, the shared memory interface 506 may include a CXL device, such as CXL device 206, the shared CXL device 314, the CXL memory device 414, or any other suitable CXL-based device. The CXL device implements shared memory that is shared between the BMC(s) 504 and the host processor(s) 508.

To provide secure links between the BMC(s) 504, the host processor(s) 508, and the shared memory, the CXL device may use one or more physical interfaces. For instance, the CXL device may use a first PCIe interface to implement a first CXL port between the host processor(s) 508 and the shared memory. The CXL device also includes a second PCIe interface to implement a second CXL port between the shared memory and one or more parts of the BMC(s) 504 (e.g., a BMC microcontroller).

The host processor(s) 508 may be similar to any of the processors 102, 204, 302, and/or 402. The host processor(s) 508 may couple to the BMC(s) 504 via at least one baseboard common to the BMC(s) 504 and the host processor(s) 508. The host processor(s) 508 are hosts that manage computing systems, such as the computing system 100, the computing system 300, and/or the computing system 400.

The PDU 510 may be a hardware device coupled to the BMC(s) 504 and/or the host processor(s) 508. The PDU 510 distributes electrical power to one or more baseboards and their connected components. For instance, the PDU 510 may provide power to memory, interface devices, fans, pumps, and the like of the host (e.g., computing system) managed by the host processor(s) 508.

The remote processor(s) 502 may couple to the BMC(s) 504 to remotely control the host by receiving measurements and status from the host and sending commands to the host. One of these commands may include changing a variable of a BIOS/UEFI of the host by sending the BIOS/UEFI variable to the BMC(s) 504 (512). For instance, the BIOS/UEFI variable may include a boot mode parameter (e.g., secure mode or safe mode), selected BIOS build parameter, a selected boot device parameter, clock speed parameter, an enabled module (e.g., a trusted platform module) parameter, driver settings, interface (e.g., PCIe connector) settings, and/or other BIOS settings. Storing the BIOS/UEFI variables may include sending the parameters and/or any associated data. For instance, the parameter for a specific BIOS build may be sent along with the BIOS build if the BIOS build is not already stored on the host. The remote processor(s) 502 may send the BIOS/UEFI variables using any suitable transfer mechanism, such as TCP/IP protocol, HTTP/HTTPs protocols, and the like over the Internet.

In response to receiving the BIOS/UEFI variables from the remote processor(s) 502, the BMC(s) 504 stores the BIOS/UEFI variables to the shared memory interface 506 (514). For instance, a BMC microcontroller of the BMC(s) 504 may use the a CXL sub-protocol, such as CXL.io and/or CXL.cache to securely access a memory region of the shared memory interface 506. For instance, the memory region may be allocated to transfers between the BMC(s) 504 and one or more of the host processor(s) 508.

The host processor(s) 508 may access and retrieve the stored BIOS/UEFI variables from the shared memory interface 506 (516). Retrieving the stored BIOS/UEFI variables may include receiving the stored BIOS/UEFI variables from the shared memory interface 506 when the shared memory interface 506 receives a change to the memory region. Additionally or alternatively, retrieving the stored BIOS/UEFI variables may be at least partially driven by the host processor(s) 508. For instance, the host processor(s) 508 may receive a notification that the memory region has changed. In response to the indication, the host processor(s) 508 may send a query to the shared memory interface 506. Based on the query, the host processor(s) 508 may receive the BIOS/UEFI variables in a response to the query. Retrieving the BIOS/UEFI variables also includes the host processor(s) 508 storing the BIOS/UEFI variables in memory (e.g., a cache) for the host processor(s) 508. This storing of the BIOS/UEFI may include storing a BIOS build to be flashed into the BIOS upon a reboot of the computing system.

To invoke the change to the BIOS/UEFI, the remote processor(s) 502 may cause the host to boot or reboot for the change to take effect. To cause the boot or reboot, the remote processor(s) 502 may transmit boot instructions to the BMC(s) 504 (518). For instance, the boot instructions may be an instruction to boot or reboot at least part of the host, such as the whole host or one or more baseboards. For instance, the BMC(s) 504 may operate to store the BIOS/UEFI variables when the host is in an off/idle mode where the computing system is not fully booted. This instruction may be received via any suitable transfer mechanism, such as TCP/IP protocol, HTTP/HTTPs protocols, and the like over the Internet.

The BMC(s) 504 transmit the boot instructions to the PDU 510 (520). The transmission of the boot instructions may be directly to the PDU 510. Additionally or alternatively, the boot instructions may be transmitted through the host processor(s) 508 by way of the shared memory interface 506 or another interface, such as IPMI. Notification of boot instructions (e.g., boot or reboot) by way of the host processor(s) 508 may occur before the boot instructions are sent to the PDU 510. Additionally or alternatively, the PDU 510 may change the power (522) to the at least part of the host (e.g., the host processor(s) 508) that is to be booted or rebooted without first sending a notification. Alternatively, the PDU 510 (and/or the BMC(s) 504) may inform the host processor(s) 508 that at least part of the host is to be rebooted by sending a change power indication.

After the power up, the host processor(s) 508 may complete power up using the stored BIOS/UEFI variables (524). For instance, the host processor(s) 508 may flash the BIOS with a BIOS build indicated in the BIOS/UEFI variables, may boot up using stored settings (e.g., secure boot mode), and the like.

During operation, the remote processor(s) 502 may transmit power cycle instructions to the BMC(s) 504 (526) to power cycle (i.e., turn on, turn off, or reboot) the computing system. These power cycle instructions may be to reboot at least part of the computing system. The power cycle instructions may be sent in response to telemetry data, based on a scheduled maintenance, based on sensor measurements, based on a manual change by an administrator, and/or any other reason that the computing system may be power cycled.

In response to receiving the power cycle instructions, the BMC(s) 504 may transmit power cycle instructions to the PDU 510 (528). The transmitted power cycle instructions may be transmitted similarly to how boot instructions are transmitted. For instance, the power cycle instructions may be transmitted to the PDU 510 by way of the host processor(s) 508 and/or via the shared memory interface 506. When the PDU 510 receives the power cycle instructions, it completes the power cycle (530) by powering down at least part of computing system and/or powering on at least part of the computing system.

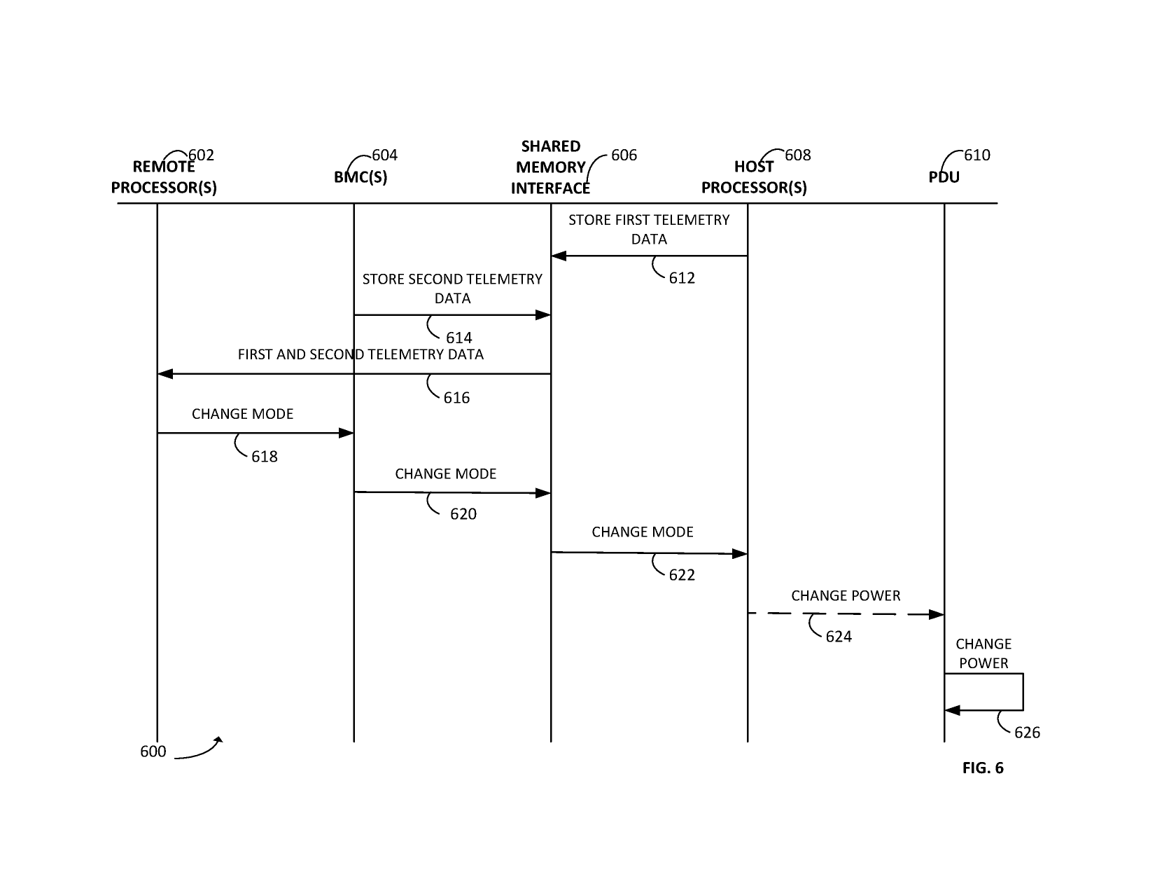

FIG. 6 is a sequence diagram of a process 600 that utilizes a shared memory to analyze telemetry data through a BMC. As illustrated, the process 600 utilizes remote processor(s) 602, baseboard management controller(s) (BMC(s)) 604, a shared memory interface 606, host processor(s) 608, and a power distribution unit (PDU) 610.

The remote processor(s) 602 may be similar to any of the processors 102, 204, 302, and/or 402. The remote processor(s) 602 may couple to the BMC(s) 604 to remotely manage computing systems, such as the computing system 100, the computing system 300, and/or the computing system 400.

The BMC(s) 604 may include BMC circuitry suitable to enable remote management of a host device (e.g., a server) including the host processor(s) 608. For instance, the BMC(s) 604 may include a suitable architecture, such as architectures discussed in relation to the BMC circuitry 108, 200, 308, or 408. The BMC(s) 604 include components to complete such management. For instance, the BMC(s) 604 may include one or more BMC microcontrollers, such as the BMC microcontroller 202.

The shared memory interface 606 includes a shared memory that is exposed to the BMC(s) 604 and the host processor(s) 608 to provide an interface between the BMC(s) 604 and the host processor(s) 608. The shared memory of the shared memory interface 606 may include a suitable memory type, such as those discussed in relation to the shared memory 112, 208, 312, and/or 412. The shared memory interface 606 may include suitable underlying interfaces. For example, the shared memory interface 606 may include a CXL device, such as CXL device 206, the shared CXL device 314, the CXL memory device 414, or any other suitable CXL-based device. The CXL device implements shared memory that is shared between the BMC(s) 604 and the host processor(s) 608.

To provide secure links between the BMC(s) 604, the host processor(s) 608, and the shared memory the CXL device may use one or more physical interfaces. For instance, the CXL device may use a first PCIe interface to implement a first CXL port between the host processor(s) 608 and the shared memory. The CXL device also includes a second PCIe interface to implement a second CXL port between the shared memory and one or more parts of the BMC(s) 604 (e.g., a BMC microcontroller).

The host processor(s) 608 may be similar to any of the processors 102, 204, 302, and/or 402. The host processor(s) 608 may couple to the BMC(s) 604 via at least one baseboard common to the BMC(s) 604 and the host processor(s) 608. The host processor(s) 608 are hosts that manage computing systems, such as the computing system 100, the computing system 300, and/or the computing system 400.

The PDU 610 may be a hardware device coupled to the BMC(s) 604 and/or the host processor(s) 608. The PDU 610 distributes electrical power to one or more baseboards and their connected components. For instance, the PDU 610 may provide power to memory, interface devices, fans, pumps, and the like of the host (e.g., computing system) managed by the host processor(s) 608.

During operation of the host (e.g., computing system that includes the host processor(s) 608), the host processor(s) 608 and/or other circuitry may store first telemetry data to the shared memory interface 606 (612). For instance, the telemetry data may include bit error rates, temperatures, latencies, throughputs, operating frequencies, and/or other information about system performance/health, usage patterns, bugs, security issues, regulatory issues, or other opportunities for improvement to operation of the host. This storing of the first telemetry data may be performed securely with low latency by using a CXL interface between the host processor(s) 608 and the shared memory interface 606.

The BMC(s) 604 may track additional telemetry using its BMC microcontroller and/or other parts of the BMC circuitry. This additional data may be any other time-series information that the BMC(s) 604 may track, such as the amount of resources consumed in communication between the BMC(s) 604 and the remote processor(s) 602 or even between different BMC(s) of a computing system. The BMC(s) 604 may store the second telemetry data to the shared memory interface 606 (614). This storing of the second telemetry data may be performed securely with low latency by using a CXL interface between the BMC(s) 604 and the shared memory interface 606.

These first and second telemetry data 614 may be stored in the shared memory accessible by the BMC(s) 604 and the host processor(s) 608. Furthermore, this data may be shared with the remote processor(s) 602 via the BMC(s) 604. Using the CXL interface between the shared memory interface 606 and the host processor(s) 608 and the CXL interface between the shared memory interface 606 and the BMC(s) 604, the first and second telemetry data may be moved securely with low latency.

To enhance or optimize operation of the host, the remote processor(s) 602 may analyze the first and second telemetry data. Thus, the host may send the first and second telemetry data to the remote processor(s) 602 (616). For instance, the first and second telemetry data may be transmitted from the BMC(s) 604 to the remote processor(s) 602. The BMC(s) 604 may retrieve this data for transmission from the shared memory interface 606 using the secure transfer links previously discussed. In some implementations, the first and second telemetry data may be sent from the shared memory interface 606 to the remote processor(s) 602 without first being sent to the BMC(s) 604.

The remote processor(s) 602 may analyze the first and second telemetry data and determine that a mode should be changed. Thus, in response to receiving and analyzing the first and second telemetry data, the remote processor(s) 602 may instruct the BMC(s) 604 to change a mode of operation (618).

In response to receiving the instruction to change modes from the remote processor(s) 602, the BMC(s) may send the change mode instruction to the shared memory interface 606 (620). For instance, the BMC(s) 604 may write the change mode instruction to a region of memory allocated to communications between the BMC(s) 604 and one or more of the host processor(s) 608. In some implementations, this memory region may be the same region used to store the first and/or second telemetry data. In other implementations, the memory region used to communicate instructions between the BMC(s) 604 and the host processor(s) 608 may be separated based on type of communication. For instance, instructions may be stored in one region of the shared memory, and telemetry data may be stored in another region of the shared memory.

This stored change mode instruction is then sent from the shared memory interface 606 to the host processor(s) 608 (622).

Sending the change mode instruction may include receiving change mode instruction from the shared memory interface 606 when the shared memory interface 606 receives a change to the corresponding memory region. Additionally or alternatively, sending the change mode instruction may be at least partially driven by the host processor(s) 608. For instance, the host processor(s) 608 may receive a notification that the memory region has changed. In response to the indication, the host processor(s) 608 may send a query to the shared memory interface 606. Based on the query, the host processor(s) 608 may receive the change mode instruction in a response to the query.

The host processor(s) 608 then act on the change mode instruction. This action may be any suitable operation, such as change a power mode, change a frequency of operation, change boot mode, and/or any other setting that may impact performance in the host.

In the illustrated embodiment, the change mode instruction indicates that power for the PDU 610 should be changed in some way. To achieve this change, the host processor(s) 608 send a change power instruction to the PDU 610 (624). For instance, the change power instruction may indicate how a supply current, frequency, or voltage used in the host should be changed. The PDU 610 then changes the power accordingly (626). In some implementations, this change power instruction may instead be sent directly from the BMC(s) 604 while the change mode instruction is also stored to the shared memory interface 606 and the host processors(s) 608 to keep the host processor(s) 608 apprised of such changes.

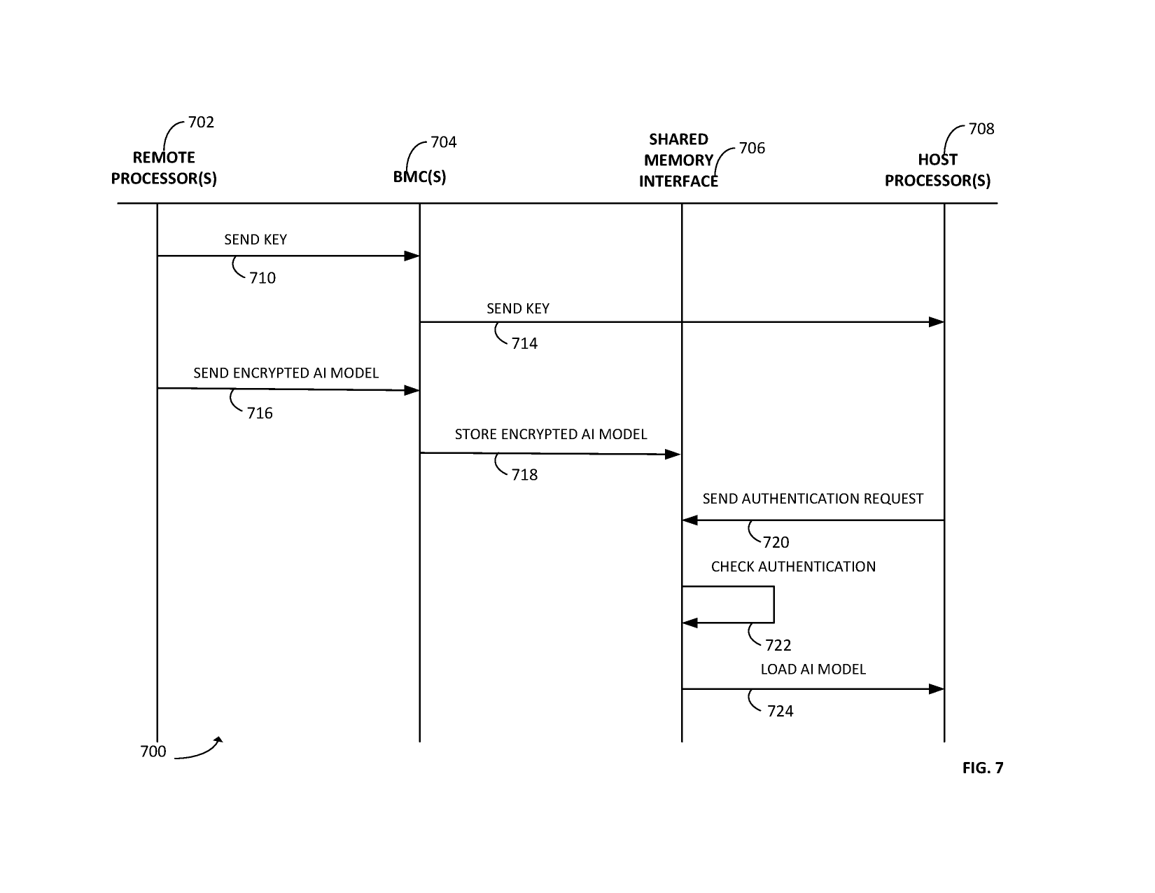

FIG. 7 is a sequence diagram of a process 700 that utilizes a shared memory to remotely and securely store an AI model via a BMC. As illustrated, the process 700 utilizes remote processor(s) 702, baseboard management controller(s) (BMC(s)) 704, a shared memory interface 706, and host processor(s) 708.

The remote processor(s) 702 may be similar to any of the processors 102, 204, 302, and/or 402. The remote processor(s) 702 may couple to the BMC(s) 704 to remotely manage computing systems, such as the computing system 100, the computing system 300, and/or the computing system 400.

The BMC(s) 704 may include BMC circuitry suitable to enable remote management of a host device (e.g., a server) including the host processor(s) 708. For instance, the BMC(s) 704 may include a suitable architecture, such as architectures discussed in relation to the BMC circuitry 108, 200, 308, or 408. The BMC(s) 704 include components to complete such management. For instance, the BMC(s) 704 may include one or more BMC microcontrollers, such as the BMC microcontroller 202.

The shared memory interface 706 includes a shared memory that is exposed to the BMC(s) 704 and the host processor(s) 708 to provide an interface between the BMC(s) 704 and the host processor(s) 708. The shared memory of the shared memory interface 706 may include a suitable memory type, such as those discussed in relation to the shared memory 112, 208, 312, and/or 412. The shared memory interface 706 may include suitable underlying interfaces. For example, the shared memory interface 706 may include a CXL device, such as CXL device 206, the shared CXL device 314, the CXL memory device 414, or any other suitable CXL-based device. The CXL device implements shared memory that is shared between the BMC(s) 704 and the host processor(s) 708.

To provide secure links between the BMC(s) 704, the host processor(s) 708, and the shared memory, the CXL device may use one or more physical interfaces. For instance, the CXL device may use a first PCIe interface to implement a first CXL port between the host processor(s) 708 and the shared memory. The CXL device also includes a second PCIe interface to implement a second CXL port between the shared memory and one or more parts of the BMC(s) 704 (e.g., a BMC microcontroller).

The host processor(s) 708 may be similar to any of the processors 102, 204, 302, and/or 402. The host processor(s) 708 may couple to the BMC(s) 704 via at least one baseboard common to the BMC(s) 704 and the host processor(s) 708. The host processor(s) 708 are hosts that manage computing systems, such as the computing system 100, the computing system 300, and/or the computing system 400.

The remote processor(s) 702 may share a key with the BMC(s) 704 (710). The key may be any suitable cryptographic key formed using a suitable encryption mechanism, such as Advanced Encryption Standard (AES) 256 or the like. In some implementations, the remote processor(s) 702 may share a single key. Additionally or alternatively, the key may be part of a public-private key pair. In some implementations, the key may be generated within the host (e.g., in the BMC(s) 704 and/or the host processor(s) 708) and shared with the remote processor(s) 702 in a direction opposite of that shown. Moreover, in some implementations, the key transmission may be replaced with alternative authentication mechanisms, such as certificate-based authentication or other pre-shared secrets.

When the BMC(s) 704 receive the key from the remote processor(s) 704, the BMC(s) 704 send the key to the host processor(s) 708 (714). For instance, the key may be sent using a first and second secure CXL links of the shared memory interface 706 by storing the key to the shared memory of the shared memory interface 706. The first secure CXL link is between the BMC(s) 704 and the shared memory interface, and the second secure CXL link is between the shared memory interface 706 and the host processor(s) 708. Alternatively, the key may be shared from the BMC(s) 704 using a link that has higher latency and/or lower throughput than is available through the CXL link since the key may be a relatively small amount of data. Furthermore, the key share may be performed at any time after authentication of the connection between the BMC(s) 704 and the remote processors(s) 702 such as at establishment of a secure tunnel through the Internet between the remote processor(s) 702 and the BMC(s) 704.

At some point during operation, the remote processor(s) 702 send an encrypted AI model to the BMC(s) 704 (716). The encrypted AI model may be encrypted using the key. Although the illustrated implementation of the process 700 shows sharing the key before sending the encrypted AI model, other implementations may include sending the encrypted AI model before sending the key.

The BMC(s) 704 then store the encrypted AI model to the shared memory interface 706 (718). For instance, the BMC(s) 704 may use a secure CXL link to store the encrypted AI model to a region of the shared memory. The region may be a region allocated to AI models or may be a region indicated as storing encrypted data. The CXL protocol may designate this region as accessible only by one or more of the BMC(s) 704 and respective one or more of the host processor(s) 708. This CXL-based fabric management ensures a layer of security in that no unauthorized devices have access to the memory region. The AI models being encrypted in the memory region may add a further layer of security. In some implementations, the key exchange and encryption of the AI models may be foregone relying on the fabric management of the CXL-based shared memory interface 706 to secure data.

The host processor(s) 708 send an authorization request to the shared memory interface 706 (720). For instance, when the host processor(s) 708 boot up, discover the shared memory interface 706 using CXL sub-protocols, or re-connect to the shared memory interface 706, the host processor(s) 708 may request access to authorized regions of memory (e.g., AI models). Additionally or alternatively, the host processor(s) 708 may request authentication to the shared memory interface 706 after receiving an indication that an AI model is available for loading into the host processor(s) 708.

The shared memory interface 706 uses this authentication request to check authentication (722). For instance, the shared memory interface 706 may use the CXL sub-protocols and stored policies to determine whether the host processor(s) 708 are to have access to the encrypted AI models.

When the shared memory interface 706 authenticates the host processor(s) 708, the shared memory interface 706 enables the host processor(s) 708 to access the and load the AI models (724). For instance, the host processor(s) 708 may access the AI models stored in the shared memory. If the AI model is encrypted, the host processor(s) 708 may then decrypt and use the AI models using the key or other shared secret.

As previously discussed, the shared memory interface 706 may be located in a top-of-rack switch. This shared memory connected to multiple baseboards may enable a secure repository for AI models that may be remotely and securely deployed to multiple baseboards without consuming all available resources for other BMC operations, such as hardware monitoring.

Although the foregoing implementations in FIGS. 5-7 relate to sharing BIOS/UEFI variables, telemetry data, or AI models using the respective shared memory interfaces, the shared memory interfaces may be used to share any suitable data. For instance, a CXL device may store OS images that may be loaded to the host when needed. This storage of the OS images provides a fail-safe mechanism to boot the respective computing system in case the primary boot device fails. Additionally or alternatively, the BMC and shared memory interfaces may be used to remotely deploy OS images for a cluster of computing systems (e.g., baseboards in a chassis). This remote deployment of OS images may speed up system updates and/or provisioning while providing a secure mechanism for such remote deployment.

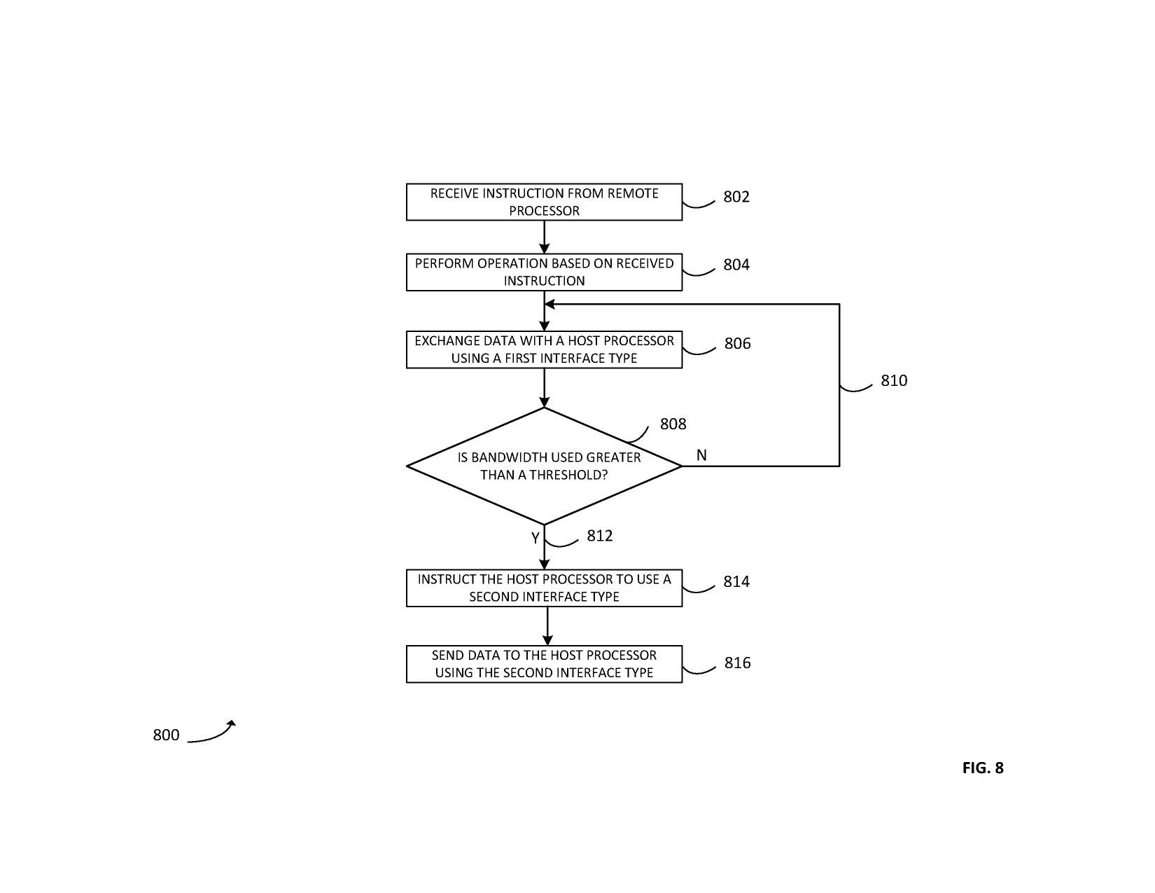

FIG. 8 is a process 800 that may be implemented by a baseboard management controller (BMC) of a computing device. For instance, the BMC may include the BMC circuitry 108, the BMC circuitry 200, the BMC circuitry 308, the BMC circuitry 408, the BMC(s) 504, the BMC(s) 604, the BMC(s) 704, and/or any other suitable BMC circuitries. For instance, the process 800 may be implemented by BMC microcontroller(s), such as the BMC microcontroller 202, and/or processor(s) of such BMCs.

The BMC receives an instruction from a remote processor (block 802). For instance, the remote processor may be any suitable processing device remote from the BMC that may establish a connection to remotely manage a host device (e.g., server) in which the BMC resides. For example, the remote processor may be similar to any of the processors(s) 102, 204, 302, 402, 502, 602, or 702.

The instruction may be any suitable instruction to remotely manage the host. For instance, the instruction may include instructions that enable accessing telemetry data, accessing remote services, transferring files, changing settings, changing device operation modes, powering down/on the host, and/or any other server administration tasks. The BMC then performs the operation based on the received instruction (block 804). For instance, the BMC may change a power mode of a power distribution unit of the host, may change a boot mode of the host, and/or other settings of the host.

The BMC also exchanges data with a host processor of the host using a first interface type (block 806). For example, the host processor may be similar to any of the processors(s) 102, 204, 302, 402, 508, 608, or 708. This exchange of data may be part of performing the operation and/or may result from performing the operation. The first interface may include a higher latency and/or lower security transfer mechanism. For instance, the first interface type may include an intelligent platform management interface (IPMI), a channel interface (CHIF), or USB interface emulating a virtual network interface card (VNIC).

The BMC may monitor whether the bandwidth consumed by the first interface type is greater than a threshold (block 808). The threshold may be an overall throughput that is not to be exceeded. Additionally or alternatively, the threshold may be related to a percentage of available throughput that is consumed. Additionally or alternatively, the threshold may be related to whether latency of prioritized BMC tasks (e.g., hardware monitoring and error tracking) has exceeded a threshold amount.

If the threshold is not surpassed (810), the BMC continues to exchange data with the host processor using the first interface type. In other words, as long as the exchange of data between the BMC and the host processor does not or is not expected to interfere with other BMC operations, the first interface type may continue to be used.

If the threshold is surpassed (812), the BMC instructs the host processor to use a second interface type (block 814). For instance, the BMC may instruct the host processor to use a CXL-based shared memory interface to exchange data with the BMC. For instance, the shared memory interface may include the shared memory 112, the CXL device 206, the shared CXL device 314, the CXL memory device 414, the shared memory interface 506, the shared memory interface 606, the shared memory interface 706, and/or any other CXL-based shared memory interfaces.

In response to instructing the host processor to use the second interface type, the BMC sends data to the host processor using the second interface type (block 816). In some implementations, only some BMC-based operations are switched to the second interface type while others remain using the first interface type. For instance, telemetry data, AI models, and/or other data that may be relatively large (e.g., larger than some size threshold) may be moved to the CXL-based shared memory interface for exchange. Sending the data to the host processor includes sending the data to the CXL-based shared memory that is mutually accessible by the BMC and the host processor using a secure CXL-based link.

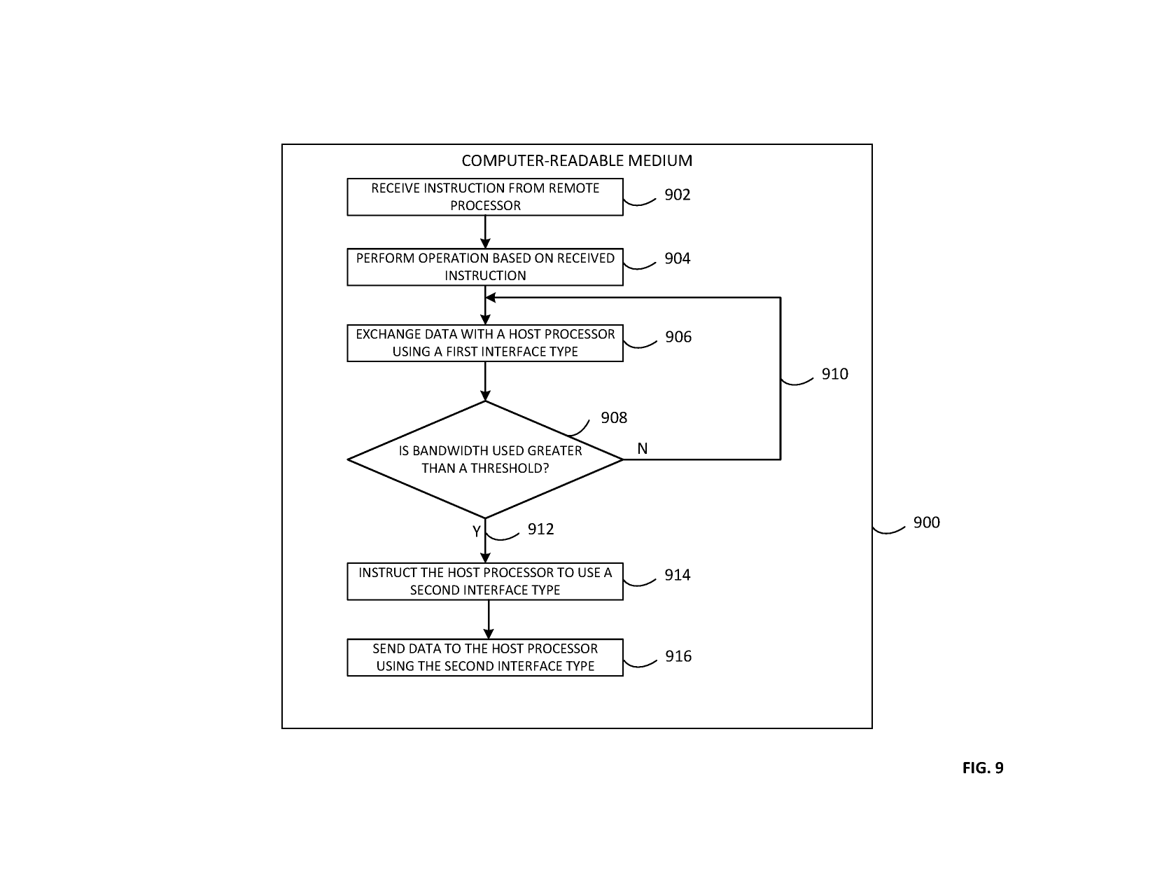

FIG. 9 is a computer-readable medium 900. The computer-readable medium 900 may be implemented in any non-transitory, computer-readable medium that stores instructions rather than transitory signals. For example, the non-transitory, computer-readable medium may include memory (e.g., memory 104, 304, 404) of a computing system. Additionally or alternatively, the non-transitory, computer-readable medium may be stored in another memory format, such as in a flash memory, a USB drive, an optical disc drive, a solid-state drive, or any other suitable memory storage medium.

The non-transitory, computer-readable medium 900 may be executed by a suitable processor, such as a baseboard management controller (BMC) microcontroller or other processor of BMC of a computing device. For instance, the BMC may include the BMC circuitry 108, the BMC circuitry 200, the BMC circuitry 308, the BMC circuitry 408, the BMC(s) 504, the BMC(s) 604, the BMC(s) 704, and/or any other suitable BMC circuitries.

When implementing the instructions of the non-transitory, computer-readable medium 900, the BMC receives an instruction from a remote processor (block 902). For instance, the remote processor may be any suitable processing device remote from the BMC that may establish a connection to remotely manage a host device (e.g., server) in which the BMC resides. For example, the remote processor may be similar to any of the processors(s) 102, 204, 302, 402, 502, 602, or 702.

The instruction may be any suitable instruction to remotely manage the host. For instance, the instruction may include instructions that enable accessing telemetry data, accessing remote services, transferring files, changing settings, changing device operation modes, powering down/on the host, and/or any other server administration tasks. The BMC then performs the operation based on the received instruction (block 904). For instance, the BMC may change a power mode of a power distribution unit of the host, may change a boot mode of the host, and/or other settings of the host.

Using the instructions of the non-transitory, computer-readable medium 900, the BMC also exchanges data with a host processor of the host using a first interface type (block 906). This exchange of data may be part of performing the operation and/or may result from performing the operation. The first interface may include a higher latency and/or lower security transfer mechanism. For instance, the first interface type may include an intelligent platform management interface (IPMI), a channel interface (CHIF), or USB interface emulating a virtual network interface card (VNIC).

Using the instructions of the non-transitory, computer-readable medium 900, the BMC may monitor whether the bandwidth consumed by the first interface type is greater than a threshold (block 908). The threshold may be an overall throughput that is not to be exceeded. Additionally or alternatively, the threshold may be related to a percentage of available throughput that is consumed. Additionally or alternatively, the threshold may be related to whether latency of prioritized BMC tasks (e.g., hardware monitoring and error tracking) has exceeded a threshold amount.

If the threshold is not surpassed (910), the BMC continues to exchange data with the host processor using the first interface type. In other words, as long as the exchange of data between the BMC and the host processor does not or is not expected to interfere with other BMC operations, the first interface type may continue to be used.

If the threshold is surpassed (912), the BMC executes instructions of the non-transitory, computer-readable medium 900 to instruct the host processor to use a second interface type (block 914). For instance, the BMC may instruct the host processor to use a CXL-based shared memory interface to exchange data with the BMC. For instance, the shared memory interface may include the shared memory 112, the CXL device 206, the shared CXL device 314, the CXL memory device 414, the shared memory interface 506, the shared memory interface 606, the shared memory interface 706, and/or any other CXL-based shared memory interfaces.

In response to instructing the host processor to use the second interface type, the instructions of the non-transitory, computer-readable medium 900 instruct the BMC to send data to the host processor using the second interface type (block 916). In some implementations, only some BMC-based operations are switched to the second interface type while others remain using the first interface type. For instance, telemetry data, AI models, and/or other data that may be relatively large (e.g., larger than some size threshold) may be moved to the CXL-based shared memory interface for exchange. Sending the data to the host processor includes sending the data to the CXL-based shared memory that is mutually accessible by the BMC and the host processor using a secure CXL-based link.

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A system, comprising:
one or more host processors;
a bus interface; and
base management controller (BMC) circuitry comprising:
a BMC microcontroller configured to perform instructions received from one or more remote electronic devices to enable the one or more remote electronic devices to manage a server device on which the BMC circuitry resides; and
a shared memory that is accessible by the one or more host processors via the bus interface and the BMC microcontroller, wherein the one or more host processors and the BMC microcontroller are configured to exchange data with each other via the shared memory.

2. The system of claim 1, wherein the shared memory comprises a Compute Express Link (CXL) Type-3device.

3. The system of claim 2, wherein the bus interface comprises a CXL peripheral component interconnect express (PCIe) bus interface configured to provide a communication path between the BMC microcontroller and the one or more host processors via the CXL Type-3 device.

4. The system of claim 1, comprising an additional bus interface between the one or more host processors and the BMC microcontroller that bypasses the shared memory.

5. The system of claim 4, wherein the additional bus interface utilizes a lower speed than the bus interface, wherein the additional bus interface is a default communication path between the one or more host processors and the BMC microcontroller, and the BMC microcontroller is configured to:
determine that a bandwidth usage between the one or more host processors and the BMC microcontroller exceeds a threshold; and
in response to the bandwidth usage exceeding the threshold, instruct the one or more host processors to use the bus interface instead of the additional bus interface.

6. The system of claim 4, wherein the additional bus interface comprises an intelligent platform management interface (IPMI) or a channel interface (CHIF).

7. The system of claim 1, wherein the BMC microcontroller is configured to:
receive a Basic Input/Output System (BIOS) variable or a unified extensible firmware interface (UEFI) variable as a received variable from the one or more remote electronic devices; and
in response to receiving the received variable, store the received variable in the shared memory.

8. The system of claim 7, wherein the one or more host processors are configured to complete an operation based on the received variable.

9. The system of claim 1, wherein the exchanged data comprises telemetry data, and the BMC microcontroller is configured to transmit the telemetry data to the one or more remote electronic devices.

10. The system of claim 1, wherein the BMC microcontroller is configured to store an artificial intelligence (AI) model to the shared memory, and the one or more host processors are configured to load the AI model from the shared memory.

11. A system, comprising:
one or more host processors;
a first baseboard coupled to the one or more host processors, wherein the first baseboard comprises:
a first bus interface;
a second bus interface; and
a BMC microcontroller configured to perform instructions received from one or more remote electronic devices to enable the one or more remote electronic devices to manage operations of the first baseboard and the one or more host processors; and
a shared memory that is accessible by the one or more host processors via the first bus interface and accessible by the BMC microcontroller via the second bus interface, wherein the one or more host processors and the BMC microcontroller are configured to exchange data with each other via the shared memory.

12. The system of claim 11, wherein the shared memory comprises a compute express link (CXL) Type-3 device, the first bus interface comprises a first CXL peripheral component interconnect express (PCIe) interface, and the second bus interface comprises a second CXL PCIe interface.

13. The system of claim 12, wherein the system comprises:
additional one or more host processors; and
a second baseboard coupled to the additional one or more host processors, wherein the second baseboard comprises:
a third bus interface;
a fourth bus interface; and
an additional BMC microcontroller configured to perform instructions received from the one or more remote electronic devices to enable the one or more remote electronic devices to manage operations of the second baseboard and the additional one or more host processors.

14. The system of claim 13, comprising a network switch that comprises the CXL Type-3 device and is configured to couple to the BMC microcontroller via the first bus interface through a first PCIe port, couple to the one or more host processors via the second bus interface through a second PCIe port, couple to the additional one or more host processors via the third bus interface through a third PCIe port, and couple to the additional BMC microcontroller via the fourth bus interface through a fourth PCIe port.

15. The system of claim 12, comprising an additional bus interface between the one or more host processors and the BMC microcontroller that bypasses the shared memory, wherein the additional bus interface utilizes a lower speed than the first and second bus interfaces, wherein the additional bus interface is a default communication path between the one or more host processors and the BMC microcontroller, and the BMC microcontroller is configured to:
determine that a bandwidth usage between the one or more host processors and the BMC microcontroller exceeds a threshold; and
in response to the bandwidth usage exceeding the threshold, instruct the one or more host processors to use the first bus interface instead of the additional bus interface.

16. A method, comprising:
receiving an instruction from a remote processor at a baseboard management controller;
in response to receiving the instruction, performing an operation using the baseboard management controller;
exchanging data between the baseboard management controller and a host processor using a first interface type;
determining, by the baseboard management controller, that a bandwidth used between the baseboard management controller and the host processor over the first interface type exceeds a threshold;
in response to the determination that the bandwidth exceeds the threshold, instructing, from the baseboard management controller via the first interface type, the host processor to use a second interface type to exchange data; and
in response to instructing the host processor to use the second interface type, sending additional data to the host processor from the baseboard management controller using the second interface type.

17. The method of claim 16, wherein the first interface type comprises an intelligent platform management interface (IPMI), a channel interface (CHIF), the second interface type comprises a compute express link (CXL) interface via a CXL Type-3 device, and sending the additional data to the host processor comprises storing the additional data to shared memory of the CXL Type-3 device accessible by the host processor.

18. The method of claim 16, comprising deploying, by the baseboard management controller, an operating system image to be loaded by the host processor to implement an operating system.

19. The method of claim 16, wherein the second interface type comprises a compute express link (CXL) memory, and the first interface type bypasses the CXL memory.

20. The method of claim 16, wherein the additional data comprises an AI model, and the baseboard management controller is configured to send the AI model to a plurality of baseboards using the second interface type, and the second interface type comprises a compute express link (CXL)-based secure link between the host processor and the baseboard management controller.
